(19) United States
(12) Patent Application Publication
(10) Pub. No.: US 2005/0288940 A1
(43) Pub. Date: Dec. 29, 2005

(54) Zodiac product concept

(75) Inventors: Denis Cushman, Fort Wayne, IN (US); Debra McClain, Fort Wayne, IN (US)

Correspondence Address: Bourque & Associates, P.A., Suite 301, 835 Hanover Street, Manchester, NH, 03104, US

(73) Assignee: Different Dreams, LLC

(21) Appl. No.: 10/863,061

(22) Filed: Jun. 8, 2004

(51) Int. Cl. G06F 17/00

(52) U.S. Cl. 705/1

(57) ABSTRACT

User-defined gemstone-based products include one or more gemstone(s) that are selected from a database of gemstone categories based on a user's birthday. Preferably at least one of the gemstone categories corresponds to a Zodiac sign and/or at least one of the gemstone categories corresponds to a month of a Gregorian calendar. In the preferred embodiment, the database of gemstone categories includes Modern birthstones, Ancient birthstones, Mystical gemstones, Zodiac gemstones, and Talismanic gemstones. Based on the birth date and Zodiac sign of the user, one or more gemstones corresponding to the user-defined gemstone categories are determined. The gemstone categories are presented to a user for selection of one or more of the gemstone categories. These gemstones and user-defined Zodiac symbol are then arranged on a user-selected piece of jewelry.

### TECHNICAL FIELD

The present invention relates to a concept wherein a person's birth date may be used to construct an individual astrological matrix that may be represented in terms of Zodiac and gemstone symbology and may be used to produce a diverse number of products (i.e., jewelry, clothes, candles, plaques, etc.).

### BACKGROUND INFORMATION

Since the beginning of humankind, people have looked to the stars and planets in awe and wonder. Beginning at least as early as ancient Greek times, people devised complex and complicated systems for forecasting the future based on the relative positions of the planets and the stars. These systems have come to be known as Astrology.

While there are many different versions of Astrology, a common theme is that they are generally based on the person's time of birth. Because the planets and stars rotate in mathematically predefined orbits, the exact location and arrangement of the planets and stars can be determined at the precise moment or time of a person's birth. Using this information, astrologers make predictions about a person's future and expose personality traits.

One common group of constellations is called the Zodiac. The Zodiac Constellations include twelve separate constellations that move about the Earth in an elliptical band that is parallel to the Earth's orbit. As the Earth moves around the Sun, the Sun comes between the Earth and each of the Zodiac constellations. Each Zodiac constellation provides unique information about a person. For example, a person born on February 8 is an Aquarius. People born under the Aquarius sign tend to be extremely adaptable and like change. They tend to dwell on past failures rather than gaining from them useful lessons for the future, and allow themselves to be dominated by regret. They often have more in common with the water signs, such as Scorpio and Cancer. They do not typically interact well with the earth signs: Taurus, Virgo and Capricorn.

While Zodiac signs alone are useful for predicting general traits about a person, every person is unique and has different experiences. As a result, Zodiac signs alone are generally not enough to generate accurate predictions. Other factors, such as the alignment of the planets, must also be taken into consideration.

Another common factor that is used to reflect a person's character and behavior are birthstones and gemstones. There are many variations of birthstones and gemstones dating back to early civilization. It is thought by many that wearing the gem appropriate to the planet or Zodiac sign concerned enhances the influence of the planets over human affairs.

Since ancient times, people have believed that different stones provide the user with various powers such as: healing and therapeutic powers, coping powers, protection from harm, nobility, and other magical and curative powers and abilities. For example, rubies are symbolic of love and passion, considered to be an aid to firm friendship, and believed to ensure beauty.

Most birthstones and gemstones are based on an individual's month of birth, as opposed to the alignment of the celestial bodies. These gemstones also have associations with the natural elements of Earth. For example, there are gemstones that represent fire, wind, water, earth, as well as others. Throughout history, Astrologers from different cultures, religions and countries have interpreted the influence of the planets and gemstones differently. Consequently, there are many different associations between the planets and gemstones that must be taken into consideration in order to provide an accurate prediction or to accurately influence a user.

While it is known to create jewelry products representing an individual's Zodiac sign or birthstone, this jewelry has generally been limited to a single astrological forecasting device or a predefined set or subset of astrological forecasting devices. Accordingly, what is needed is a method of providing an individual customizable jewelry products based on one or more astrological forecasting devices. The method should preferably include both celestial-based astrological forecasting devices as well as mythical, Talismanic and/or amulet-based stones.

It is important to note that the present invention is not intended to be limited to a device or method which must satisfy one or more of these objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a method of manufacturing gemstone jewelry and other products that is indicative of at least two attributes of an individual. The method includes providing an individual with a database of gemstone and Zodiac symbology categories. The gemstone categories include a plurality of gemstones wherein each gemstone represents certain attributes based on the individual's birth date and associated Zodiac sign. In the preferred embodiment, the gemstone and Zodiac categories include at least one or more gemstone category wherein at least one of the gemstone categories corresponds to a Zodiac sign and wherein at least one of the gemstone categories corresponds to a month of a Gregorian calendar. In the exemplary embodiment, the database of gemstone categories includes the gemstone categories chosen from the group consisting of Modern birthstones, Ancient birthstones, Mystical gemstones, Zodiac gemstones, and Talismanic gemstones.

In the preferred embodiment, the present invention features gemstone-based jewelry products comprising jewelry selected from the group consisting of rings, bracelets, necklaces, anklets, earrings, etc. The jewelry is adapted to contain at least one gemstone and user associated Zodiac symbol. The gemstones are selected from a database of gemstone categories including a plurality of gemstones having at least one gemstone category corresponding to a Zodiac sign and/or at least one gemstone category corresponding to a month of a Gregorian calendar.

In another embodiment, the database of gemstone categories includes Modern birthstones, Ancient birthstones, Mystical gemstones, Zodiac gemstones, and Talismanic gemstones.

The product preferably includes at least one gemstone corresponding to a Zodiac sign and at least one gemstone corresponding to a month of a Gregorian calendar. For example,

a jewelry product may include gemstones selected from the group comprising birthstones and Zodiac gemstones, gemstones selected from the group comprising birthstones and Talismanic gemstones, gemstones selected from the group comprising birthstones, Zodiac gemstones, Mystical gemstones, and Talismanic gemstones, and at least one gemstone corresponding to a Zodiac sign and at least one gemstones corresponding to a month of a Gregorian calendar (depending upon the specific Individual's birth date).

Next, an individual selects one or more of the gemstone categories corresponding to the individual's Zodiac sign and date of birth (month & day). Finally, the individual selects a type of jewelry product, for example but not limited to, jewelry selected from the group consisting of rings, bracelets, necklaces, anklets, earrings, etc. The gemstones are then arranged within the selected type of jewelry product along with the Individual's defined Zodiac symbol.

### BRIEF DESCRIPTION OF THE DRAWINGS

These and other features and advantages of the present invention will be better understood by reading the following detailed description, taken together with the drawings wherein:

FIG. 1 is a plan view of two embodiments of gemstone-based jewelry products according to the present invention;

FIGS. 2-5 are charts showing various gemstone and Zodiac symbols and their associated attributes;

FIG. 6A is a block diagram of a gemstone database according to one embodiment of the present invention;

FIG. 6b is a chart showing various gemstone categories and their correlation to the Zodiac and Gregorian months according to one embodiment of the present invention; and

FIG. 7 is a flowchart illustrative of a process to determine the user-selected gemstones according to one embodiment of the present invention.

### DETAILED DESCRIPTION OF THE PREFERRED EMBODIMENTS

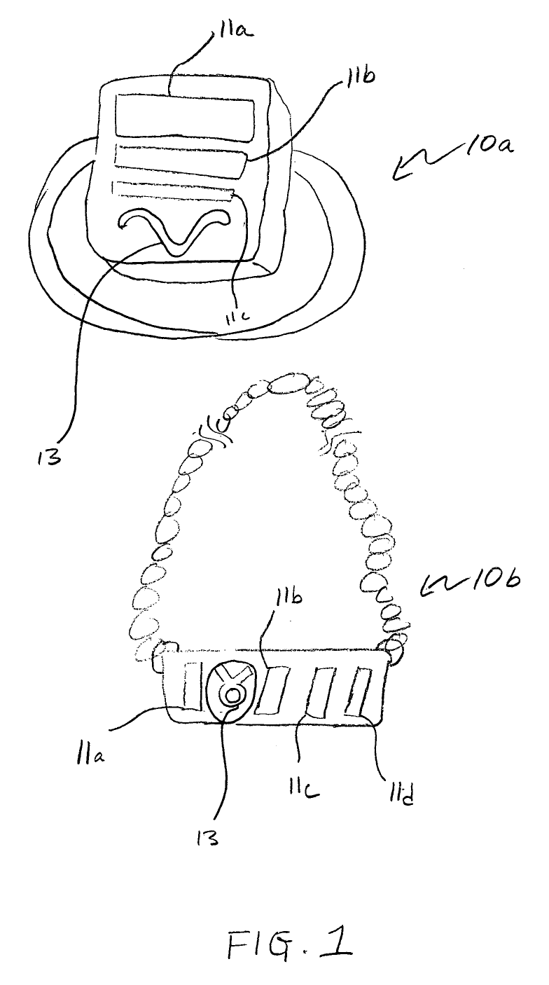

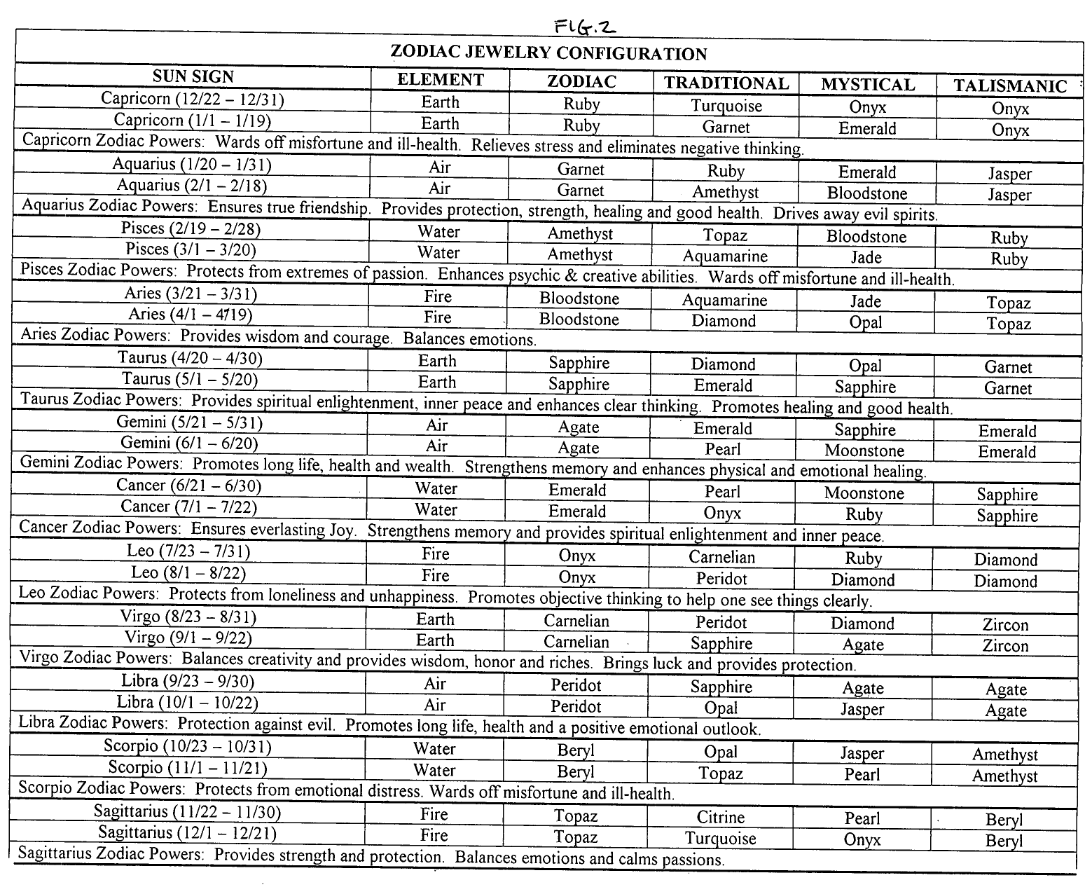

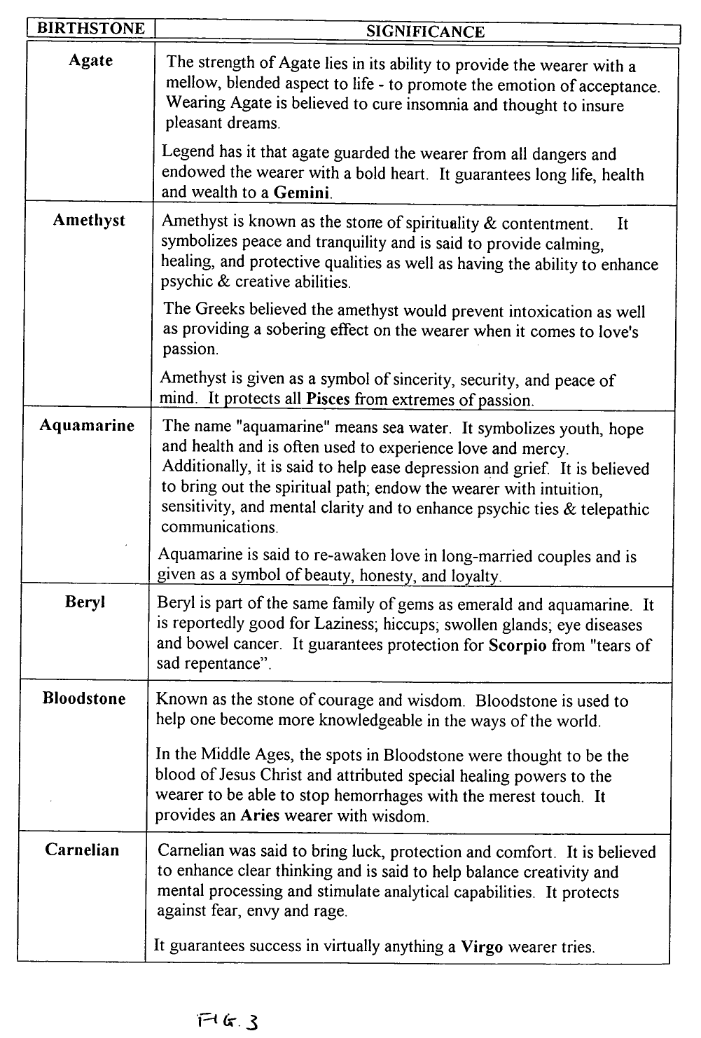

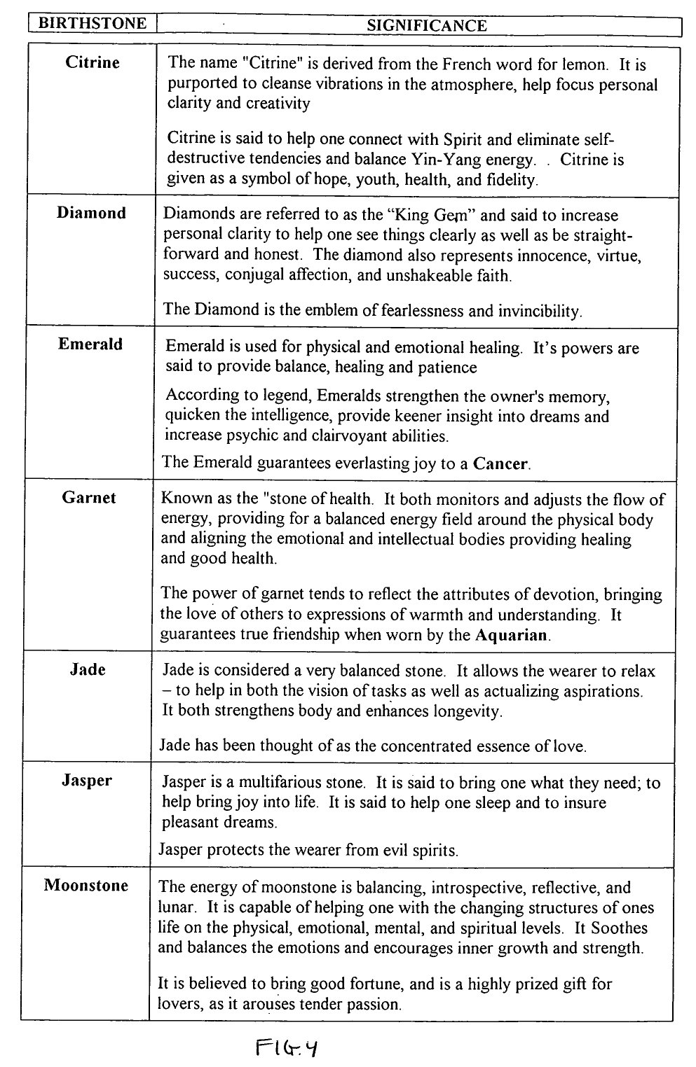

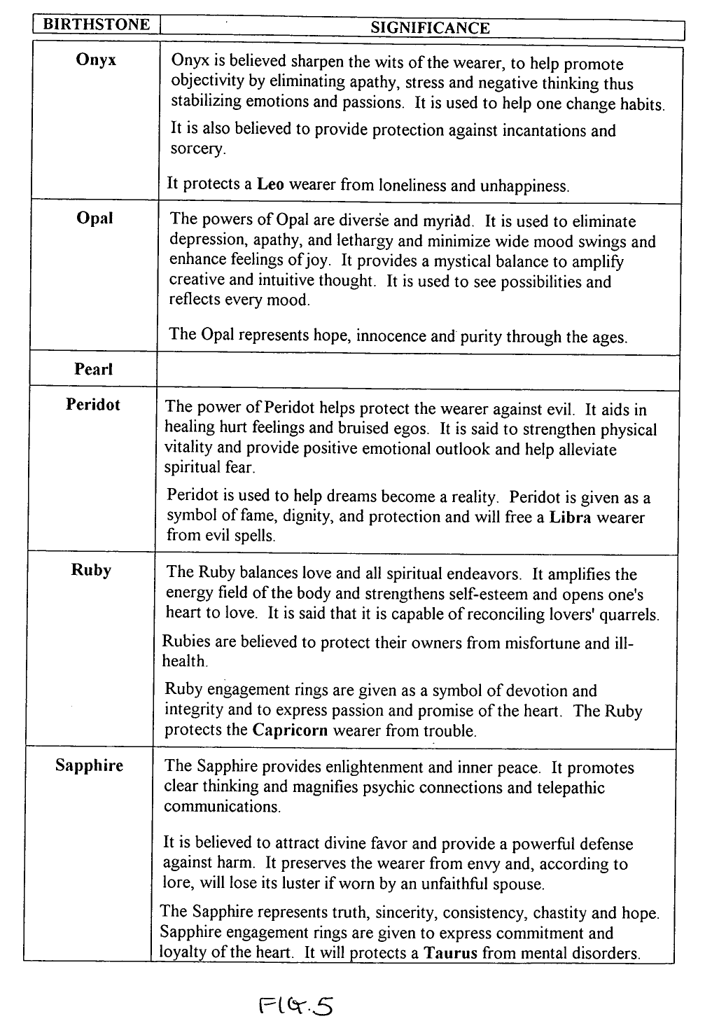

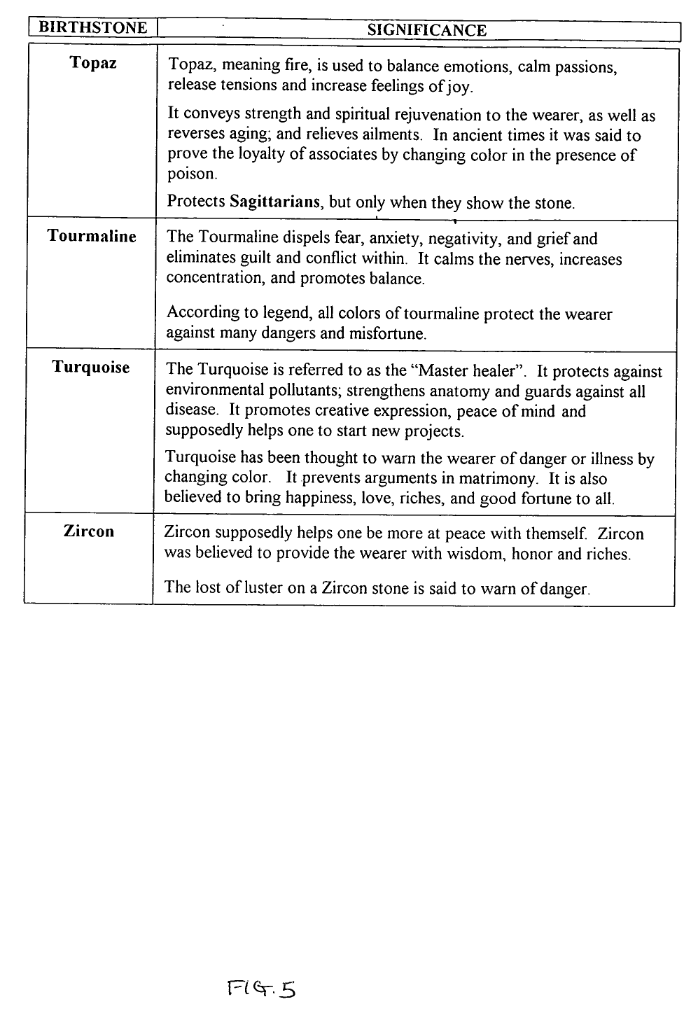

User-defined gemstone-based jewelry 10, FIG. 1, according to the present invention, includes at least one gemstone 11 arranged in one a Zodiac product, for example a piece of jewelry, with the individual's associated Zodiac symbol 13 as will be explained in great detail here and below. The gemstones 11, specifically defined by an individual's birth date, are believed by many to be representative of attributes of the individual. These attributes may be either present attributes or future, desired attributes. Many different attributes are associated with gemstones 11, see for example, FIGS. 2-5 for an explanation of some of the attributes associated with various signs and gemstones. These attributes and various gemstone associations are generally referred to as gemstone categories. For example, strength and willpower are often generally associated with red gemstones 11 such as, but not limited to, carnelian, garnet, red jasper, and ruby. The stones 11 also have associations with the planet Mars and as well as the element of fire. Accordingly, it is desirable by many people to wear products (i.e., jewelry 10) associated with two or more desirable attributes.

Choosing the correct gemstones 11 and Zodiac symbols 13, however, is not simply a matter of picking one's favorite gemstones 11 and Zodiac symbol 13. As will be explained in greater detail hereinbelow, gemstone selections are based on an individual's particular month and day of birth. The different gemstone categories define the particular gemstones 11 corresponding to an individual's birth date. The various correlations and associations of the gemstone categories define a plurality of characteristics for different individuals.

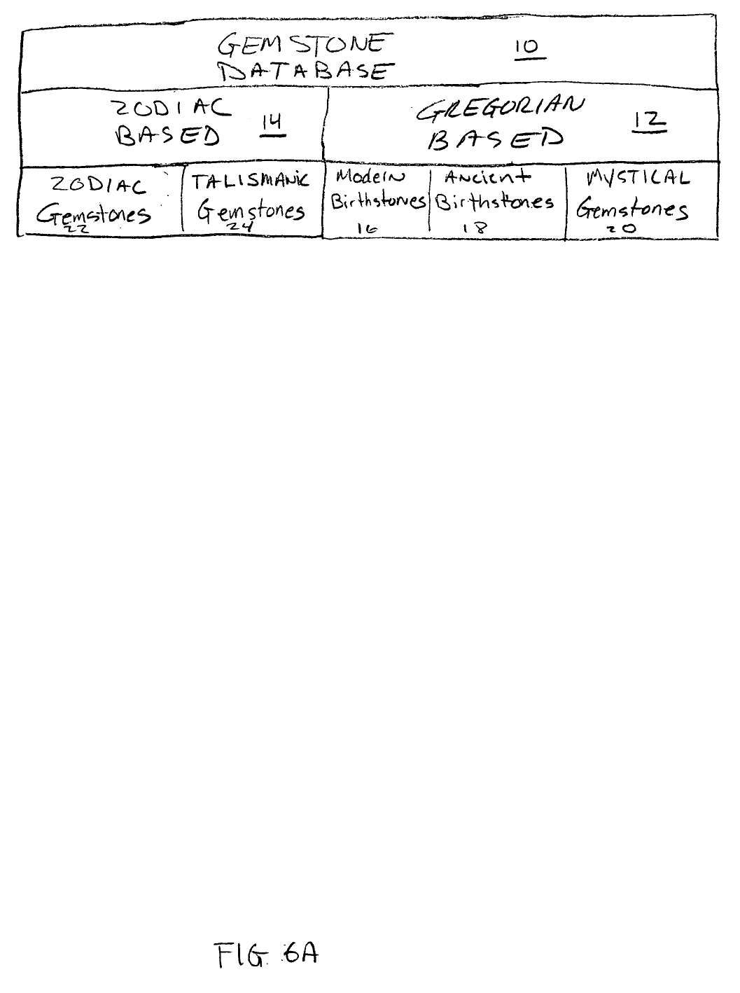

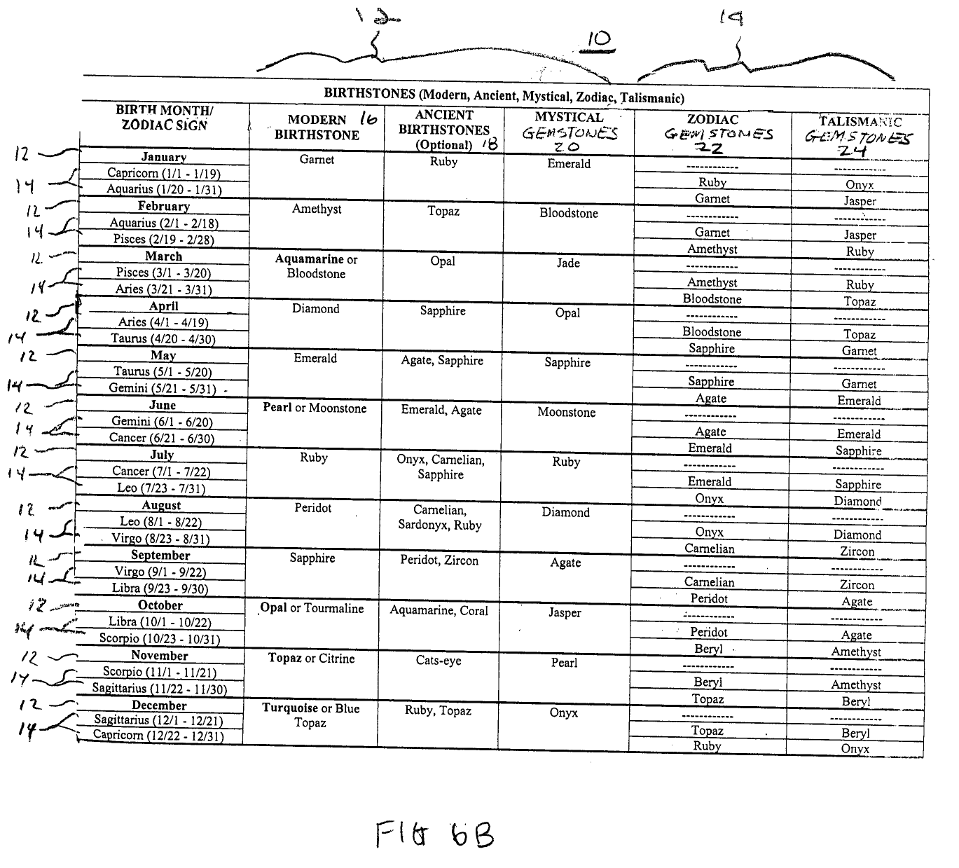

To formulate the correct arrangement of gemstones 11 and Zodiac symbols 13 to represent the user-defined astrological product, the present invention includes a database 10, FIG. 6A and 6B, of gemstone categories. The gemstone database 10 includes Gregorian based gemstones 12 as well as Zodiac based gemstones 14.

The Gregorian based gemstones 12 are based on the traditional, Gregorian calendar months of January, February, March, April, May, June, July, August, September, October, November, and December. The Gregorian calendar was constructed to give a close approximation to the tropical year, which is the actual length of time it takes for the Earth to complete one orbit around the Sun. Each of the Gregorian based gemstones categories corresponding to a single Gregorian month. Thus, the Gregorian based gemstones 12 depend on the particular month of an individual's birth, rather then the specific day within the month.

According to the preferred embodiment, the present invention features include Gregorian based gemstone categories 12 including: Modern birthstones 16, Ancient birthstones 18, and Mystical gemstones 20. For illustrative purposes only, a person born in the month of February would have the following Gregorian based gemstones 12 corresponding to their Modern birthstone 16, Ancient birthstone 18, and Mystical gemstones 20: amethyst, topaz, and bloodstone, respectively.

In contrast, the Zodiac-based gemstones 14 are based on the twelve Zodiac constellations rather then the twelve-month traditional, Gregorian based calendar. The Zodiac constellations rotate about the Earth in an elliptical orbit. As the Earth orbits around the Sun, the Sun crosses in front of each one of the Zodiac constellations in the same order every year.

As a result, the Zodiac calendar does not correlate to the traditional, Gregorian calendar. Therefore, a single month of the Zodiac calendar overlaps at least two Gregorian months. Consequently, the particular day of an individual's birth in the Zodiac calendar is relevant in determining the appropriate Zodiac gemstone. According to the preferred embodiment, the present invention features of following Zodiac based gemstone categories 14: Zodiac gemstones 22 and Talismanic gemstones 24.

For illustrative purposes only, a person born on February 8 would be represented by the Zodiac symbol Aquarius and would have the following Zodiac-based gemstone categories 14 corresponding to their Zodiac and Talismanic gemstones 22, 24: garnet and jasper, respectively. In contrast, a person born on February 19 would be represented by the Zodiac symbol Pisces and would have the following Zodiac-based gemstone categories 14 corresponding to their Zodiac and Talismanic gemstones 22, 24: amethyst and ruby, respectively. Both people, however, would have the same Gregorian based gemstones 12.

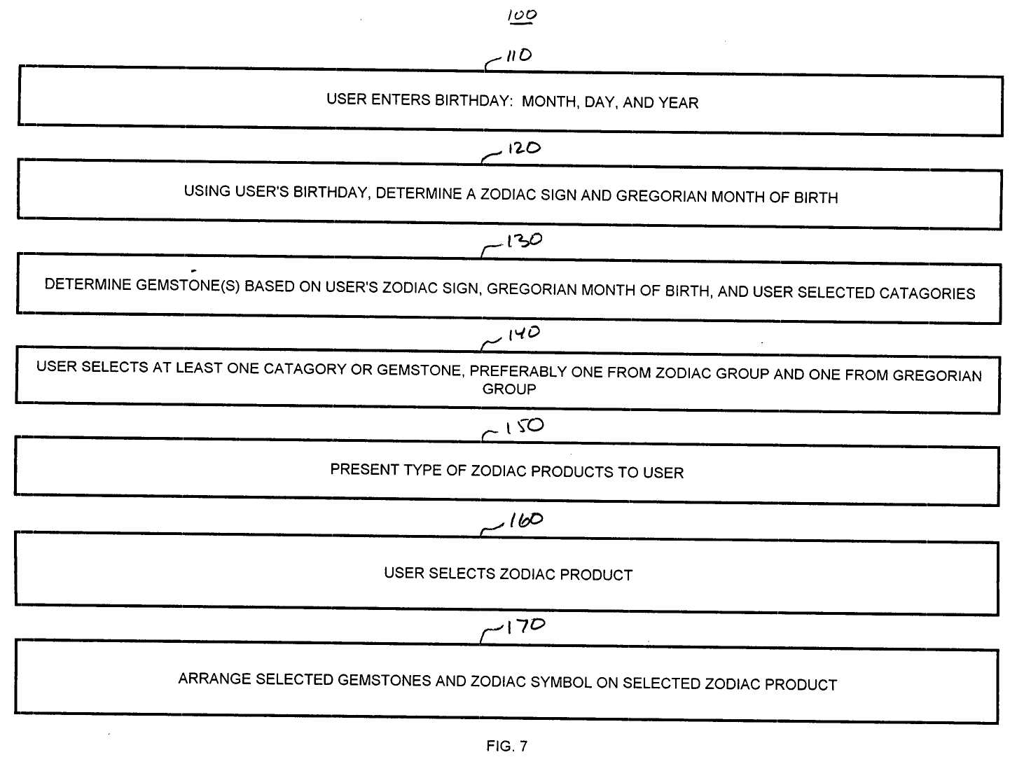

To determine the correct correlation of Zodiac symbol 13 and gemstones 11, the present invention includes a method 100, FIG. 7, wherein an individual would enter his/her date of birth, (i.e., month and day), act 110. Based on the individual's date of birth, the individual's Zodiac sign 13 and Gregorian month of birth can be determined, act 120. Next, the gemstones 11 in each gemstone category for that individual are determined, act 130, based on the individual's birth date and Zodiac sign 13. The individual then selects one or more gemstone categories or stones 11, act 140.

It is also necessary to determine the desired type of product 10 in which the selected, user-defined gemstones 11 and Zodiac symbol 13 will be arranged. To accomplish this, a list of Zodiac products 10, for example different types of jewelry, is presented to the user, act 150. For exemplary purposes only, the list of types of jewelry 10 includes, but is not limited to, rings, bracelets, earrings, necklaces, anklets, etc. Other types of Zodiac products 10 are also envisioned. From this list, the user selects at least one type of jewelry 10, act 160.

Once the individual's Zodiac symbol 13 and associated gemstones 11 are determined and the user-selected type of Zodiac product 10 is determined, the gemstone(s) 11 are arranged on the user-selected type of Zodiac product 10, act 170, along with the individual's Zodiac symbol 13.

As mentioned above, the present invention is not intended to be limited to a device or method which must satisfy one or more of these objects or features of the invention and should not be limited to the preferred, exemplary, or primary embodiment(s) described herein. Modifications and substitutions by one of ordinary skill in the art are considered to be within the scope of the present invention, which is not to be limited except by the following claims.

1. A method of manufacturing Zodiac-based products comprising:
providing a user with a database of Zodiac symbology and at least two gemstone categories, each of said at least two gemstone categories including a plurality of gemstones;
determining Zodiac symbology and gemstones applicable to said user corresponding to a Zodiac symbol and gemstone categories based upon a birth date of said user;
user selecting at least one of said gemstones determined applicable to said user;
selecting a type of product; and
arranging said at least one user-defined gemstones with said Zodiac symbol on said selected type of product.

2. The method as claimed in claim 1 wherein said database of gemstone categories includes at least one gemstone categories chosen from the group consisting of Modern birthstones, Ancient birthstones, Mystical gemstones, Zodiac gemstones, and Talismanic gemstones.

3. The method as claimed in claim 2 wherein said act of selecting at least one of said gemstone categories includes selecting at least two of said gemstone categories, wherein at least one of said gemstone categories corresponds to a Zodiac sign and wherein at least one of said gemstone categories corresponds to a month of a Gregorian calendar.

4. The method as claimed in claim 1 wherein said database of gemstone categories includes at least one gemstone category corresponding to a Zodiac sign and at least one gemstone category corresponding to a month of a Gregorian calendar.

5. The method as claimed in claim 1 wherein said act of determining gemstones applicable to said user corresponding to said gemstone categories based upon said birth date of said user further includes determining a user's Zodiac sign.

6. The method as claimed in claim 1 wherein said act of selecting said type of product includes jewelry products selected from the group consisting of rings, bracelets, necklaces, anklets, and earrings.

7. A product made in accordance with the method as claimed in claim 1.

8. A method of manufacturing gemstone products comprising:
assembling a database of gemstone categories including a plurality of gemstones representative of user attributes, wherein at least one of said gemstone categories corresponds to a Zodiac sign and wherein at least one of said gemstone categories corresponds to a month of a Gregorian calendar;
presenting said database to a user for selection of at least one of said gemstone categories;
determining a birth date of said user;
determining a Zodiac sign corresponding to said birth date of said user;
selecting at least one gemstone corresponding to said user-defined selection of gemstone categories responsive to said birth date of said user and said Zodiac sign of said user;
choosing a type of product; and
arranging said gemstones and associated Zodiac symbol within said user-selected type of product, wherein said gemstone product is representative of at least one attribute of said user.

9. The method as claimed in claim 8 wherein said database of gemstone categories includes said gemstone categories are chosen from the group consisting of Modern birthstones, Ancient birthstones, Mystical gemstones, Zodiac gemstones, and Talismanic gemstones.

10. The method as claimed in claim 9 wherein said act of selecting at least two of said gemstone categories includes selecting at least three of said gemstone categories.

11. The method as claimed in claim 8 wherein said act of selecting said type of product includes jewelry products selected from the group consisting of rings, bracelets, necklaces, anklets, and earrings.

12. A piece of jewelry made in accordance with the method as claimed in claim 11.

13. A gemstone-based product comprising jewelry products selected from the group consisting of rings, bracelets, necklaces, anklets, and earrings, said jewelry products containing at least one gemstone, said at least one gemstone being selected from a database of gemstone categories including a plurality of gemstones having at least one of said gemstone categories corresponding to a Zodiac sign and at least one of gemstone categories corresponding to a month of a Gregorian calendar.

14. The gemstone-based product as claimed in claim 13 wherein said database of gemstone categories includes Modern birthstones, Ancient birthstones, Mystical gemstones, Zodiac gemstones, and Talismanic gemstones.

15. The gemstone-based product as claimed in claim 14 wherein said product includes at least one gemstone corresponding to a Zodiac sign and at least one gemstone corresponding to a month of a Gregorian calendar.

16. The gemstone-based product as claimed in claim 15 wherein said product includes gemstones selected from the group comprising birthstones and Zodiac gemstones.

17. The gemstone-based product as claimed in claim 15 wherein said product includes gemstones selected from the group comprising birthstones and Talismanic gemstones.

18. The gemstone-based product as claimed in claim 15 wherein said product is adapted to contain at least three gemstones.

19. The gemstone-based product as claimed in claim 18 wherein said product includes gemstones selected from the group comprising birthstones, Zodiac gemstones, Mystical gemstones, and Talismanic gemstones.

20. The gemstone-based product as claimed in claim 14 wherein said product includes at least one gemstone corresponding to a Zodiac sign and at least one gemstone corresponding to a month of a Gregorian calendar.
